(19) United States
(12) Patent Application Publication
(10) Pub. No.: US 2024/0308445 A1
(43) Pub. Date: Sep. 19, 2024

(54) SYSTEM WITH MULTIPLE DRIVE MODULES, DRIVE MODULE FOR AT LEAST ONE ACTUATOR OF A WHEEL OR AXLE OF A VEHICLE, VEHICLE INCLUDING THE SYSTEM, AS WELL AS METHOD FOR TEACHING DRIVE MODULE IDENTIFIERS

(71) Applicant: ZF CV Systems Europe BV, Brussels (BE)

(72) Inventors: Robert Sohn, Hannover (DE); Ralph Schumacher, Norderstedt (DE); Carsten Lehr, Hannover (DE); Johann Lucas, Sehnde (DE)

(21) Appl. No.: 18/676,041

(22) Filed: May 28, 2024

Related U.S. Application Data
(63) Continuation of application No. PCT/EP2022/081188, filed on Nov. 9, 2022.

(30) Foreign Application Priority Data
Nov. 25, 2021 (DE) 10 2021 130 880.1

(51) Int. Cl. B60R 16/023; B60R 16/033

(52) U.S. Cl. CPC B60R 16/0231; B60R 16/033

(57) ABSTRACT

A system includes multiple drive modules, each for at least one actuator of a wheel or an axle of a vehicle. Each drive module has a bus interface for connecting to a bus, a switching signal input and a switching signal output. The drive module is configured to operate in an operating mode and a learning mode. The drive module has a switch and is configured to use the switch in the operating mode to conductively connect the switching signal input to the switching signal output and, after a transition from the operating mode to the learning mode, to interrupt the connection between the switching signal input and the switching signal output. The drive modules are connected in series via the switching signal inputs and switching signal outputs.

### CROSS-REFERENCE TO RELATED APPLICATIONS

This application is a continuation application of international patent application PCT/EP2022/081188, filed Nov. 9, 2022, designating the United States and claiming priority from German application 10 2021 130 880.1, filed Nov. 25, 2021, and the entire content of both applications is incorporated herein by reference.

### TECHNICAL FIELD

The disclosure relates to the field of vehicles and in particular to the field of commercial vehicles. Vehicles have a large number of sensors and actuators, for example in the area of their chassis. Such actuators control or regulate, for example, functions of the wheel suspension, the steering or the brakes depending on measured values captured with corresponding sensors. Drive modules are used to actuate the actuators and read out the measurement data.

### BACKGROUND

Such drive modules are used, for example, in adjustable air suspension systems. In such air suspension systems, spiral or leaf springs are replaced by air springs that contain bellows that can be filled with gas, such as air, to provide the spring effect. Via variable gas pressures or variable gas masses of the air springs, these are adjustable and enable additional functions, such as level control. In the case of a self-levelling system, the ground clearance of a vehicle can be adjusted by adjusting the gas masses. The gas masses are adjusted, for example, depending on the terrain to be driven on or a vehicle load, that is, a total vehicle mass.

Since the behavior of the air springs of air suspension systems has a direct effect on the handling of a vehicle with the air suspension system, adjustable air suspension systems are subject to complex control mechanisms to enable the best possible comfort and safety. For example, the distance between the vehicle frame, body or body parts, such as a wheel arch, and a wheel suspension is constantly monitored. The gas pressures of the individual air springs are also monitored. A large number of valves for wheel-specific ventilation or venting of the air springs are then controlled depending on the monitoring. These valves can therefore be described as actuators that are actuated by wheel-specific or axle-specific drive modules.

In addition to the large number of actuators, such as valves, a large number of drive modules for actuating these actuators are also arranged in a vehicle. For example, a drive module is provided for each axle of a vehicle. The drive modules are usually coordinated by a higher-level control unit. For this purpose, the control unit and the drive modules are connected via a common bus. A bus here and below refers to a data bus, such as a CAN bus. The advantage of such a bus is that a single cable or data line is required to connect all modules. This reduces the amount of cabling required compared to a separate connection of each individual drive module to the control unit for data exchange.

The modules, especially the drive modules, thus exchange messages with the control unit on the bus in order to be able to carry out coordinated control or regulation of the actuators. In order to identify the origin of the messages on the bus and also to identify the intended recipients of the messages on the bus, each subscriber connected to the bus uses a unique drive module identifier, which can also be referred to as an identification or identifier. In the aforementioned drive modules, this drive module identifier is usually stored in the software of the drive module, as individual production of the drive modules for predefined mounting positions in the vehicle is often uneconomical.

According to the prior art, there are essentially two known procedures for storing a drive module identifier in the drive module. According to the first procedure, the drive modules are programmed with a drive module identifier according to their subsequent installation position before they are installed in a vehicle. However, special care must be taken here. The drive modules which are programmed according to their desired position before installation must actually be installed in the vehicle at the intended installation position. If the modules are swapped, it will not be possible to guarantee proper functioning at a later date. This is a non-negligible source of error during the manufacturing process of a vehicle.

In order to exclude the mentioned source of error, an alternative procedure is known. In this approach, the drive modules are first installed in the vehicle without a programmed drive module identifier at any position of multiple positions at each of which a drive module is to be arranged. Only at the end of production, after the so-called EOL, are the drive modules programmed with a drive module identifier via a programming interface, for example the control unit or another higher-level control or regulating instance. However, this subsequent programming requires a time-consuming additional step in the commissioning of a vehicle. In order to clearly identify the individual drive modules, it is always necessary to deploy personnel in addition to just a sequence of a programming process. The personnel is used for the targeted selection of the drive module to be programmed with a drive module identifier during programming. This is done, for example, by activating a learning procedure with a button or the like on the respective drive module.

### SUMMARY

It is an object of the disclosure to address the problems of the prior art. In particular, it is intended to simplify the learning of a unique drive module identifier of a drive module that is operated with multiple other drive modules on a common bus. At the very least, an alternative to the prior art should be proposed.

For this purpose, the disclosure relates to a system including: a multiplicity of drive modules each for at least one actuator of a wheel or an axle of a vehicle; each of the multiplicity of drive modules including a bus interface for connecting to a bus, a switching signal input, and a switching signal output; each of the multiplicity of drive modules being configured to be operated in an operating mode and in a learning mode; each of the multiplicity of drive modules having a switch and being configured to use the switch to conductively connect the switching signal input to the switching signal output in the operating mode, and, after a transition from the operating mode to the learning mode, to interrupt the connection between the switching signal input and the switching signal output; and, the multiplicity of drive modules being connected in series via the switching signal inputs and the switching signal outputs.

According to the disclosure, a system containing multiple drive modules is proposed. Each of the drive modules is intended for at least one actuator of a wheel or an axle, that is, is assigned to at least one actuator of a wheel or an axle of a vehicle. Each of the drive modules contains a bus interface for connecting to a bus. In addition, each of the drive modules has a switching signal input and a switching signal output. In addition, each of the drive modules is set up to operate in an operating mode and in a learning mode. In addition, each of the drive modules contains a switch. For example, the switch is a relay, especially a semiconductor relay. In any case, the switch is used to establish and disconnect an electrical connection between the switching signal input and the switching signal output.

In addition, each of the drive modules is set up to conductively connect the switching signal input to the switching signal output with the switch in the operating mode. In addition, the switch of each of the drive modules is set up to interrupt a connection between the switching signal input and the switching signal output after a transition from the operating mode to the learning mode. The drive modules are connected in series through the switching signal inputs and the switching signal outputs of the drive modules. In other words, the drive modules are connected in series with respect to their switching signal inputs and switching signal outputs.

A series connection of the drive modules includes, for example, in the case that a number of N drive modules are provided, that a first of the drive modules has a switching output that is connected to a switching input of a second of the N drive modules. The switching output of the second of the N drive modules is then connected to the switching signal input of another, for example the Nth drive module. The switching signal output of the Nth drive module remains disconnected. Accordingly, preferably with a number of N drive modules, one of the switching signal outputs of N-1 of the drive modules is connected to exactly one switching signal input of N-1 drive modules. Thus, with exactly one of the N drive modules, the switching signal output remains unconnected, that is, it is not connected to a switching signal input of one of the N drive modules. In exactly one of the other N drive modules, a switching signal input remains unconnected, that is, it is not connected to a switching signal output of one of the N drive modules.

After a transition from an operating mode to a learning mode, it is possible to successively select the drive modules for learning a drive module identifier by switching the drive modules back on one after the other via the switching signal input according to their series connection. This learning can be carried out automatically after an initial activation of the drive modules or, if necessary, by requesting a learning mode. This makes it unnecessary to store drive module identifiers in advance in the drive modules or to manually select the drive modules to learn a drive module identifier.

According to an embodiment of the system, it contains a control unit with a bus interface. All bus interfaces of the drive modules and the control unit are connected to each other via a bus. Preferably, the bus is looped through the drive modules. This means that each drive module has a bus interface input and a bus interface output, wherein these are constantly conductively connected to each other. This means that when the series connection is made through the switching signal inputs and switching signal outputs, a bus connection of the modules can also be established at the same time with two additional wires for the bus interface by plugging a single input plug and a single output plug into each of the drive modules.

Furthermore, the disclosure relates to a drive module. The drive module is preferably a drive module of the system or for the system. Particularly preferably, each of the drive modules of the system is of the form of the drive module described below.

The drive module contains a bus interface for connecting to a bus. The bus here refers to a field bus, that is, a bus system that is used to transmit data in the form of data packets, which can also be called messages. The bus used here is particularly preferably a CAN bus, namely a controller area network bus. Accordingly, the bus interface for connecting to the bus is preferably a CAN bus interface. In addition, the drive module contains a switching signal input and a switching signal output. Also, the module is set up to operate in an operating mode and in a learning mode. The module also has a switch. The switch, for example, is a relay, especially a semiconductor relay. The module is set up to use the switch in the operating mode to conductively connect the switching signal input to the switching signal output and to interrupt the connection between the switching signal input and the switching signal output after a transition from the operating mode to the learning mode, that is, in the learning mode.

According to an embodiment of the drive module, it is set up to monitor communications on the bus with the bus interface in the learning mode. Furthermore, the drive module is set up in the learning mode in order to set, store, program or save a drive module identifier of the drive module depending on the monitored communication.

If, for example, the monitoring determines that there has been no communication on the bus so far, the drive module recognizes that it is the first drive module to learn a drive module identifier. In this case, a drive module identifier is set that corresponds to a first drive module identifier of a set of predefined drive module identifiers, such as a number 1. In the event that messages are already being sent on the bus, the drive module checks during monitoring, for example, which drive module identifiers are already contained in the messages. The drive module then selects a free drive module identifier, that is, a drive module identifier with which no messages have been sent on the bus so far, and sets this drive module identifier. Preferably, this drive module identifier is a next higher drive module identifier in the predefined sequence of drive module identifiers. The next higher drive module identifier corresponds to the drive module identifier with the lowest position in the predefined sequence with which no messages have been sent on the bus so far. A specific example is that a first and a second drive module are already sending messages on the bus and messages from the first module have the number 1 as the drive module identifier and messages from the second module have the number 2 as the drive module identifier. The monitoring drive module in the learning mode detects that the next higher drive module identifier is the number 3 and that this number 3 is not yet sending messages on the bus. The drive module carrying out the monitoring in the learning mode then sets its own drive module ID to the number 3.

In a subsequent step, after setting the drive module identifier, the drive module is set up in the learning mode to use the switch to conductively connect the switching signal input to the switching signal output. Particularly preferably, the drive module switches back to the operating mode during or immediately after switching and sends messages on the bus itself with the previously set or learned drive module identifier.

With this embodiment it is ensured that in the learning mode, the drive module automatically selects a free drive module identifier and sets it automatically.

According to another embodiment the drive module is set up, after setting a drive module identifier in the learning mode to output a message, which can also be called a learning success message, with the set drive module identifier to a control unit via or at the bus interface. Furthermore, after sending the learning success message, the drive module is set up to receive a response message from the control unit via the bus interface. The response message includes an expected next drive module identifier. In the event that the response message contains a drive module identifier other than the previously set one, that is, the expected next drive module identifier differs from the previously set drive module identifier, the drive module is set up in the learning mode to switch from the learning mode to the operating mode and perform the aforementioned step, that is, to conductively connect the switching signal input to the switching signal output via the switch.

The learning success message with the set drive module identifier to the control unit serves to inform the control unit that the drive module has set a drive module identifier and, in particular, which drive module identifier has been set. The response message is then used by the drive module to recognize that the learning success message has been received by the control unit. Accordingly, it has been registered by the control unit that the drive module has set a drive module identifier. The control unit also signals with the response message that it is waiting for a setting of the next drive module, signaled by a learning success message of the next drive module. An automatic setting of the drive module identifiers of all drive modules is thus made possible with minimal data traffic on the bus during a learning phase or initialization phase, which is only completed when the last drive module switches from the learning mode to the operating mode.

According to another embodiment, the module is set up to perform the previously mentioned steps of the present embodiment after a switching signal is applied to the switching signal input or is detected. For example, the switching signal is a voltage with a value that is above a predefined threshold. Thus, after a drive module previously connected in series switches the switching signal further through to the switching signal input of a drive module via the switching signal output, the drive module can recognize that it can now monitor the communication on the bus in order to then set a suitable drive module identifier.

According to another embodiment, the drive module contains a supply input to receive a supply energy for the operation of the module. Alternatively, it is possible to supply the drive module directly via the switching signal input with supply energy for the operation of the module. In this alternative embodiment, no supply input would have to be provided. However, it was recognized that by providing an additional supply line to supply the drive module, a switching signal input line has to transmit a smaller amount of energy via the supply input and is thus relieved of load. The switching signal inputs and switching signal outputs as well as the switches can thus be dimensioned comparatively small, for example in order to transmit a comparatively lower current than is required for supplying energy. The configuration of the switches and corresponding internal cables of the drive module can thus be carried out more cost-effectively.

According to another embodiment, the drive module is connected to at least one sensor or has at least one sensor. Alternatively or additionally, the drive module is connected to at least one actuator or has at least one actuator. The drive module is thus used to capture measured values and to actuate one or more actuators.

According to another embodiment, the drive module is set up to output a sensor value of a connected or integrated sensor, preferably including height information, rotation angle information, a displacement sensor value or a pressure sensor value, especially preferably together with the drive module identifier, to the control unit at the bus interface after setting the drive module identifier. A sensor value, in particular a current sensor value of the drive module, can thus be output to the control unit in the learning mode or when the learning mode is completed in order to inform it of the status of the sensor. In particular, it is possible to initialize the sensor with the first message from the drive module to a control unit.

According to another embodiment, the drive module is an air suspension drive module for actuating at least one valve for ventilating and/or venting an air spring. The valve is particularly preferably a component of the drive module. In addition, the drive module has at least one pressure sensor, height sensor or displacement sensor. Air suspension systems often contain multiple air suspension drive modules, each of which is assigned to an axle of a vehicle. Thus, a configuration of an air suspension drive module as a drive module of the disclosure is advantageous in order to carry out an initialization of the air suspension system in a simple way with the mentioned advantages.

Furthermore, the disclosure includes a vehicle with at least one drive module according to one of the aforementioned embodiments or a system according to one of the aforementioned embodiments.

According to an embodiment of the vehicle, a switching signal line of the vehicle is connected to a first switching signal input of a first of multiple drive modules that are connected in series. The switching signal line corresponds to or carries an ignition positive of the vehicle as a switching signal. The ignition positive of the vehicle can also be called a switched positive and is an expression of motor vehicle electrical engineering. The ignition positive refers to the positive electric terminal of a vehicle battery that is switched with the ignition switch. This ignition positive is often referred to as terminal 15, for example according to DIN 72552. Alternatively or additionally, the supply connection of each of the drive modules is connected to a supply line of the vehicle, in particular a direct positive line coming from the battery. The supply line is therefore the positive line directly from the battery, which is often referred to as terminal 30 according to DIN 72552.

Furthermore, the disclosure includes a method for teaching drive module identifiers of multiple drive modules, which are in particular configured according to one of the aforementioned embodiments. The method first includes receiving a learning request prompt from a control unit by all drive modules via a bus to which the control unit and all drive modules are each connected via a bus interface. In the next step, the method involves the drive modules switching from an operating mode to a learning mode after receiving the learning request prompt. After switching from the operating mode to the learning mode, a connection between a switching signal input and a switching signal output in each of the drive modules is interrupted by each of the drive modules.

Furthermore, the method includes the reception of a switching signal at the switching signal input of a drive module. Once the switching signal has been detected, communication on the bus with the bus interface is monitored by the drive module that received the switching signal. In addition, a drive module identifier of the drive module is set depending on the monitored communication. After setting the drive module identifier, the switch is then used to conductively connect the switching signal input to the switching signal output again.

According to another embodiment, the control unit expects a first predefined drive module identifier after the learning request prompt is sent. This drive module identifier is preferably expected as a message, especially as a learning success message, via the bus. After a first received drive module identifier is received, in particular in the form of a message as described above, the control unit checks whether the received message has a drive module identifier that corresponds to the first predefined drive module identifier, which is also referred to here as the first expected drive module identifier, or whether the first received drive module identifier corresponds to the first predefined drive module identifier. In the event that the first received drive module identifier corresponds to the first expected drive module identifier, that is, the drive module identifiers match, the control unit sends a response message over the bus with an expected new or second drive module identifier that is different from the first expected drive module identifier.

### BRIEF DESCRIPTION OF DRAWINGS

The invention will now be described with reference to the drawings wherein:

FIG. 1 shows a system with multiple drive modules and a control unit;

FIG. 2 shows a drive module in the form of an air suspension drive module;

FIG. 3 shows a vehicle with a system; and,

FIG. 4 shows steps of a method.

### DETAILED DESCRIPTION

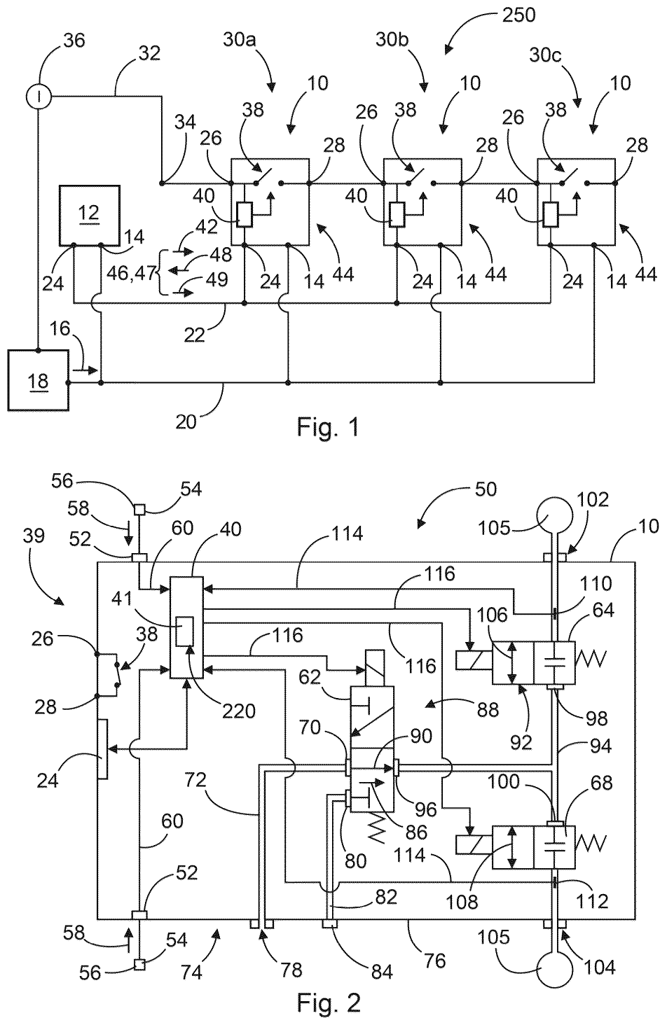

FIG. 1 shows multiple drive modules 10 and a control unit 12. The control unit 12 and the drive modules 10 each have a supply input 14. The drive modules 10 each receive their supply energy 16 from a vehicle battery 18 via a supply line 20 and the supply input 16. The supply input 16 preferably provides a positive potential relative to a zero potential or ground equivalent to a connection to a negative terminal of a vehicle battery 18. A connection for a zero potential or a connection to the negative terminal of the vehicle battery 18 are not shown for a better overview.

All drive modules 10 and the control unit 12 are connected via a bus 22 for the exchange of data. The bus 22 is preferably a CAN bus 23. A CAN bus 23 usually has more than one line and is represented here by a connecting line as an example. The control unit 12 and the drive modules 10 each have a bus interface 24, wherein all bus interfaces 24 are connected to the bus 22.

In addition, each of the drive modules 10 has a switching signal input 26 and a switching signal output 28. The drive modules are connected in series via their switching signal inputs 26 and switching signal outputs 28. For this purpose, a first drive module 30a is connected with its switching signal output 28 to a switching signal input 26 of a second drive module 30b. The switching signal output 28 of the second drive module 30b is connected to a switching signal input 26 of a third drive module 30c. The switching signal output 28 of the third drive module 30c is unconnected because the system shown has no other drive modules 10. The first drive module 30a is connected with its switching signal input 26 and a switching signal line 32 to an ignition positive 34, which can be separably connected to the vehicle battery 18, namely the positive terminal of the vehicle battery 18, for example via an ignition switch 36.

A switch 38 is provided in each of the drive modules, with which the switching signal input 26 can be disconnected from or connected to the switching signal output 28. The switch 38 can be controlled by a processor 40 of the drive module 10. Furthermore, the processor 40 is also connected to the bus 22. If a message which corresponds to a learning request prompt 42 is sent from the control unit 12 to the drive modules 10 via the bus 22, this message is received by the processor 40 of each of the drive modules 10 and the switch 38 is opened in each case, so that a connection between the respective switching signal inputs 26 and the respective switching signal outputs 28 is disconnected. This is shown in FIG. 1, so that the drive modules 10 are in a learning mode 44 in this state. With reference to the later FIG. 4, this learning mode 44 is described in more detail, wherein further messages 46, which can also be called data packets 47, such as a learning success message 48 or a response message 49, are also transmitted via the bus 22.

FIG. 2 shows a more detailed but still schematic representation of a drive module 10, which is in the form of an air suspension drive module 50. The air suspension drive module 50 contains the bus interface 24, which is connected to the processor 40. The processor 40 receives messages 46 via the bus interface 24 and transmits messages 46 with a unique drive module identifier 220 stored in a memory 41 of the processor. The processor 40 controls the switch 38, which can connect the switching signal input 26 to the switching signal output 28 or can create an interruption or disconnection of the connection. In the present case, the switch 38 is closed, so that the drive module 10 shown is in an operating mode 39 compared to a learning mode 44 in which the switch 38 would be open.

In addition, the processor 40 is connected to a large number of other components of the drive module 10. According to the embodiment shown here, the processor 40 is connected to two sensor interfaces 52, each of which is connected to a sensor 54. The sensors 54 are displacement sensors 56 here. Such displacement sensors 56 provide displacement sensor values 58, which include, for example, a distance between a wheel suspension and a chassis of a vehicle. The processor 40 can output these distance values, which can also be called height values 60, via the bus interface 24 to the bus 22 in order to feed them to the control unit 12.

In addition, the processor 40 is connected to three valves 62, 64, 68, which are part of the drive module 10. The processor 10 is used to actuate the valves 62, 64, 68 when a message 46 is received from the control unit 12 via the bus interface 24 which requires one or more valves 62, 64, 68 to be actuated. The three valves 62, 64, 68 are in the form of electropneumatic valves.

One of the valves 62, 64, 68, hereinafter referred to as the first valve 62, is in the form of a 3/2-way valve. In this case, the first valve 62 has an input 70, to which a pressure source, especially a compressed air source, can be connected. For this purpose, the input 70 is routed via a compressed air line 72 to the outside 74 of the housing 76 of the drive module 10 and forms a compressed air connection 78 here. Furthermore, an output 80 is provided on the first valve 62, which is also routed to the outside 74 of the housing 76 via a compressed air line 82. On the outside 74 of the housing 76, a sound attenuator 84 is arranged at the end of the compressed air line 82.

In the position shown, that is, the state or switching state of the first valve 62 shown, air can be fed with a flow rate 86 through the first valve 62 to the valves 64, 68 by a pressure source connected to the compressed air connection 78. For this purpose, the first valve 62 has a conduction cross-section 90 in its shown position, namely its conductive position 88.

The valves 64 and 68 are closed in the position shown, namely in the closed position 92. The valve 64 is hereinafter referred to as the second valve 64 and the valve 68 is hereinafter referred to as the third valve 68. If the valves 64 and 68 are switched by actuating them with the processor 40, the compressed air supplied by the first valve 62 may flow out through a compressed air line 94 which is routed from an output 96 of the first valve 62 to inputs 98, 100 of the second valve 64 and the third valve 68, through the second valve 64 and the third valve 68 and to outputs 102, 104 of the drive module 10. The second valve 64 has a second conduction cross-section 106 and the third valve 68 has a third conduction cross-section 108. An air spring 105 of an air suspension system 153 can be connected at each of the outputs 102, 104.

Furthermore, in a conductive position of the second valve 64 and the third valve 68, which is not shown here, compressed air can be discharged from the air springs through the first valve 62 and through the compressed air line 82 by switching the first valve 62 to a discharge position of the first valve 62 which is not shown. For this purpose, the sound attenuator 84 is configured to reduce the noise generated when venting the air spring 105. In the shown closed position 92 of the second valve 64 and the third valve 68, an air pressure in the air springs 105, which are connected to the outputs 102, 104, can be measured by pressure sensors 110, 112 integrated into the connection module 10.

A pressure sensor value 114 captured with these pressure sensors 110, 112 can be converted into a message of a bus 22 by the processor 40, as with the already mentioned displacement sensor values 58, and output via the bus interface 24. In addition, the processor 40 controls the valves 62, 64 and 68 via actuating signals 116.

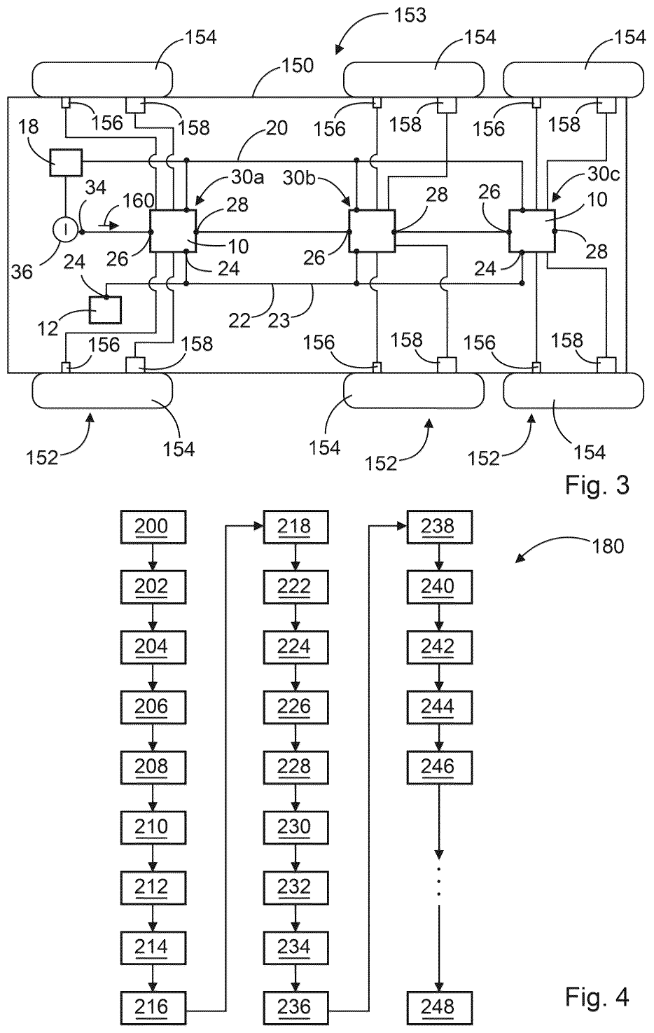

FIG. 3 shows a vehicle 150 with three 152 axles, each with two wheels 154. The vehicle 150 has a system 250, which can also be in the form of an air suspension system 153. Each of the axles 152 is assigned a drive module 10. The drive module 10 is connected to a control unit 12 via a bus 22 in order to exchange data in the form of messages 40, which can also be called data packets 47. Furthermore, each of the drive modules 10 is connected to two sensors 156, wherein each sensor is assigned exactly to one wheel 154. Furthermore, in addition to the sensor 156, an actuator 158 is assigned to each wheel 154, wherein two actuators 158 of an axle 152 are connected to the drive module 10 assigned to the axle 152. In addition, as already shown in FIG. 1, the drive modules 10 are connected to a vehicle battery 18 and are connected in series with their switching signal inputs 26 and switching signal outputs 28, wherein a first switching signal input 26 of a first drive module 30a is connected to an ignition positive 34. This means that the first drive module 30a, even if it is in the learning mode 44, can receive a switching signal 160 from the ignition positive 34.

FIG. 4 shows the steps of a method 180 for teaching drive module identifiers of multiple drive modules 10. In a step 200, which takes place for example when a vehicle 150 is put into operation for the first time, all drive modules 10 are in an operating mode 39. In step 202, the control unit 12 requests a transition of the drive modules 10 from the operating mode 39 to the learning mode 44 by sending a learning request prompt 42 as a message 46 on the bus. In addition, in step 204, an expected drive module identifier in the control unit 12 is set to a first expected drive module identifier. In step 206, all drive modules 10 receive the learning request prompt 42 and switch from the operating mode 39 to the learning mode 44 in step 208. In step 210, all switching signal outputs 28 of the drive modules 10 are disconnected from the switching signal inputs 26 of the modules by the switchover.

A first drive module 30a of the drive modules 10 receives a switching signal 160 via its switching signal input 26 in step 212. In step 214, this drive module 10, namely the first drive module 30a, monitors communications on the bus 22. In step 216, the first drive module 30a detects that no communication, that is, no message, is being sent on the bus 22. The drive module 10 then learns a first predefined drive module identifier 220 in step 218 and sends this drive module identifier 220 to the control unit 12 in step 222 together with displacement sensor values 58 captured by a displacement sensor 56 connected to the first drive module 30a. In step 224, control unit 12 receives the first drive module identifier 220 and compares it in step 226 with the first expected drive module identifier from step 204. In step 228, the received displacement sensor values 58 are entered into a list for the first drive module 30a. In step 230, the control unit 12 then sets the expected drive module identifier to a second expected drive module identifier and sends out the next expected drive module identifier on the bus in step 232. In step 234, the drive module 10, which has previously learned the first predefined drive module identifier 220, detects that a message is being sent on the bus 22 with a different drive module identifier than the one 220 it learned. The first drive module 30a then switches back to the operating mode 39 in step 236. In step 238, the switch 38 of the first drive module 30a is closed at the same time in order to connect the switching signal input 26 to the switching signal output 28. In the operating mode 39, the first drive module 30a, which has previously learned the drive module identifier 220, now regularly transmits messages characterized by its drive module identifier 220 on the bus 22 in step 240.

By closing the switch in step 238, the next drive module 10 receives a switching signal 160 at the switching signal input 26 in step 242. In step 244, the next drive module 10 determines that messages 46 are being sent on the bus 22 with a drive module identifier 220 of the first drive module 30a and learns a different drive module identifier 220 in step 246, namely, for example, a drive module identifier 220 that is the next drive module identifier 220 in a predefined sequence. In the following steps, the steps from step 222 onwards are repeated, but for the subsequent drive modules 10, until all drive modules 10 have switched back to the operating mode 39. The learning of the drive module identifiers 220 is then completed in step 248.

It is understood that the foregoing description is that of the preferred embodiments of the invention and that various changes and modifications may be made thereto without departing from the spirit and scope of the invention as defined in the appended claims.

### REFERENCE SIGN LIST [PART OF DESCRIPTION]

10 Drive Modules
12 Control unit
14 Supply Input
16 Supply energy
18 Vehicle battery
20 Supply line
22 Bus
23 CAN bus
24 Bus Interface
26 Switching signal input
28 Switching signal output
30a First drive module
30b Second drive module
30c Third drive module
32 Switching signal line
34 Ignition positive
36 Ignition lock
38 Switch
39 Operating mode
40 Processor
41 Memory
42 Learning request prompt
44 Learning mode
46 Message
47 Data packets
48 Learning success message
49 Response message
50 Air suspension drive module
52 Sensor Interface
54 Sensor
56 Displacement sensor
58 Displacement sensor values
60 Height value
62 First valve
64 Second valve
68 Third valve
70 Input
72 Compressed air line
74 Outside
76 Housing
78 Compressed air connection
80 Output
82 Compressed air line
84 Sound attenuator
86 Flow rate
88 Conductive position
90 Conduction cross-section
92 Closed position
94 Compressed air line
96 Output
98 Input
100 Input
102 Output
104 Output
105 Air spring
106 Conduction cross-section
108 Conduction cross-section
110 Built-in pressure sensor
112 Built-in pressure sensor
114 Pressure sensor value
116 Drive signal
150 Vehicle
152 Axle
153 Air suspension system
154 Wheel
156 Sensor
158 Actuator
160 Switching signal
180 Method
200 Drive modules in operating mode
202 Sending out learning request prompt
204 Setting drive module identifier
206 Receiving learning request prompt
208 Switching to the learning mode
210 Disconnection of switching signal outputs from switching signal inputs
212 Capturing switching signal
214 Monitoring communications
216 Finding no communication
218 Learning a first predefined drive module identifier
220 Drive module identifier
222 Transmitting drive module identifier
224 Receiving drive module identifier
226 Comparing drive module identifiers
228 Entering displacement sensor values in a list
230 Changeover to second drive module identifier
232 Transmission of second drive module identifier
234 Recognizing other drive module identifier
236 Switching to the operating mode
238 Closing Switch
240 Sending Messages
242 Receiving switching signal
244 Determination of message sending
246 Learning different drive module identifiers
248 Completion of learning drive module identifiers
250 System

1. A system comprising:
a multiplicity of drive modules each for at least one actuator of a wheel or an axle of a vehicle;
each of said multiplicity of drive modules including a bus interface for connecting to a bus, a switching signal input, and a switching signal output;
each of said multiplicity of drive modules being configured to be operated in an operating mode and in a learning mode;
each of said multiplicity of drive modules having a switch and being configured to use said switch to conductively connect said switching signal input to said switching signal output in said operating mode, and, after a transition from said operating mode to said learning mode, to interrupt the connection between said switching signal input and said switching signal output; and,
said multiplicity of drive modules being connected in series via said switching signal inputs and said switching signal outputs.

2. The system of claim 1 further comprising a control unit with a bus interface and all said bus interfaces of said multiplicity of drive modules and said control unit are connected to each other via a bus.

3. A drive module for at least one actuator of a wheel or axle of a vehicle, the drive module comprising:
a bus interface for connecting to a bus;
a switching signal input;
a switching signal output;
wherein the drive module is configured to be operated in an operating mode and in a learning mode;
a switch; and,
the drive module being configured, via said switch, to connect said switching signal input to said switching signal output in said operating mode and to interrupt the connection between said switching signal input and said switching signal output after a transition from said operating mode to said learning mode.

4. The drive module of claim 3, wherein the drive module is configured, in said learning mode, to:
a) monitor a communication on the bus with said bus interface;
b) set a drive module identifier of the drive module depending on the monitored communication; and,
c) after setting the drive module identifier, conductively connect said switching signal input to said switching signal output via said switch.

5. The drive module of claim 4, wherein the drive module is configured, after setting the drive module identifier, to output a learning success message with a set drive module identifier to a control unit via said bus interface, to receive a reply message with an expected next drive module identifier from the control unit via said bus interface and, in an event that a response message includes a drive module identifier different from the set drive module identifier, to change from the learning mode to said operating mode and to conductively connect said switching signal input to said switching signal output via said switch after setting the drive module identifier.

6. The drive module of claim 3, wherein, after a switching signal is received at said switching signal input, the drive module is configured, in said learning mode, to:
monitor a communication on the bus with said bus interface;
set a drive module identifier of the drive module depending on the monitored communication; and,
after setting the drive module identifier, conductively connect said switching signal input to said switching signal output via said switch.

7. The drive module of claim 3 further comprising a supply input for receiving supply energy for operation of the drive module via said supply input.

8. The drive module of claim 3, wherein at least one of:
the drive module is connected to at least one sensor or has at least one sensor; and,
the drive module is connected to the at least one actuator or has the at least one actuator.

9. The drive module of claim 5, wherein the drive module is configured to output a sensor value to the control unit at the bus interface after the drive module identifier is set.

10. The drive module of claim 9, wherein the sensor value is output together with the drive module identifier.

11. The drive module of claim 9, wherein the sensor value is a displacement sensor value.

12. The drive module of claim 3, wherein the drive module is an air suspension drive module for actuating a valve for at least one of supplying air to and venting an air spring; and, the drive module is connected or is connectable to at least one displacement sensor or a pressure sensor.

13. A vehicle comprising the system of claim 1.

14. A vehicle comprising the drive module of claim 3.

15. The vehicle of claim 13 further comprising a control unit.

16. The vehicle of claim 13, wherein at least one of:
a switching signal of a first drive module of the multiplicity of drive modules is connected to an ignition positive of the vehicle; and,
the supply connection is connected to a battery of the vehicle.

17. A method for teaching drive module identifiers of multiple drive modules, the method comprising:
receiving a learning request prompt from a control unit by all of the multiple drive modules via a bus to which the control unit and all the multiple drive modules are connected;
changing the drive modules from an operating mode to a learning mode after receipt of the learning request prompt; and,
interrupting a connection between a switching signal input and a switching signal output in each of the multiple drive modules by each of the drive modules with a switch.

18. The method of claim 17, wherein each of the multiple drive modules includes:
a bus interface for connecting to a bus;
a switching signal input;
a switching signal output;
wherein the multiple drive modules are configured to be operated in an operating mode and in a learning mode;
a switch; and,
the multiple drive modules being configured, via the switch, to connect the switching signal input to the switching signal output in the operating mode and to interrupt the connection between the switching signal input and the switching signal output after a transition from the operating mode to the learning mode.

19. The method of claim 17 further comprising:
capturing a switching signal at the switching signal input of one of the multiple drive modules;
the method, after said capturing the switching signal at the switching signal input further comprising:
monitoring a communication on the bus with a bus interface with the multiple drive modules;
setting a drive module identifier of the multiple drive modules depending on the monitored communication; and,
after setting the drive module identifier, connecting the switching signal input to the switching signal output with the switch with the multiple drive modules.

20. The method of claim 17, wherein the control unit expects a first predefined expected drive module identifier after sending the learning request prompt and after receiving a first message with a first received drive module identifier from a drive module of the multiple drive modules, checks whether this drive module identifier corresponds to the first predefined expected drive module identifier; and, in an event that the first received and the first predefined expected drive module identifiers agree, the control unit sends a second message with a second predefined drive module identifier different from the first predefined expected drive module identifier.

21. The method of claim 20 wherein at least one of: the first message is a learning success message and the second message is a response message.
